(19) United States
(12) Patent Application Publication
(10) Pub. No.: US 2020/0073781 A1
(43) Pub. Date: Mar. 5, 2020

(54) SYSTEMS AND METHODS OF INJECTING FAULT TREE ANALYSIS DATA INTO DISTRIBUTED TRACING VISUALIZATIONS

(71) Applicant: salesforce.com, inc., San Francisco, CA (US)

(72) Inventor: Andrey Falko, Oakland, CA (US)

(21) Appl. No.: 16/115,801

(22) Filed: Aug. 29, 2018

(51) Int. Cl. G06F 11/36; G06F 8/41

(52) U.S. Cl. CPC G06F 11/364; G06F 11/3664; G06F 8/433; G06F 11/3612; G06F 11/3608

(57) ABSTRACT

Systems and methods are provided for performing, at a computing system, a code trace of at least a portion of computer code having a plurality of components that are executed by the computing system. A dependency map may be generated for the plurality of components of the computer code based on the code trace, the dependency map identifying at least an upstream component that is executed upstream of a first component of the plurality of components and a downstream component that is executed downstream of the first component. An observed failure rate may be determined of at least the first component, based on at least one of the upstream component and the downstream component. A fault tree analysis map that includes the generated dependency map and the observed failure rate of at least the first component of the plurality of components may be displayed on a display device.

### BACKGROUND

Present distributed tracing systems allow for a user to view visualizations of how programming components in a user's system communicate with each other. Such systems typically generate a “dependency map,” which can be displayed in a graph-like structure having nodes and pathways. In order to determine failure rates of software components in the dependency map, a user must manually analyze data that is collected for the software components to determine if there is a failure. Other present systems merely provide a listing of each step of a tracing operation, and provide times indicating how long each operation took to complete. A user must review each step to determine whether there is a delay for one or more operations of the system, or a failure of an operation.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1A-1D show a method of performing a code trace, generating a dependency map, and generating a fault tree analysis map including the dependencies between components, observed failure rates, and predicted failure rates of the components according to implementations of the disclosed subject matter.

FIG. 2A shows an example fault tree analysis map that may be displayed that includes observed failure rates according to an implementation of the disclosed subject matter.

FIG. 2B shows a portion of an example fault tree analysis map that includes observed failure rates of components and predicted failure rates based on at least one changed component according to an implementation of the disclosed subject matter.

FIG. 2C shows a display that ranks components based on an observed failure rate according to an implementation of the disclosed subject matter.

FIG. 3 shows a portion of a computing system that includes a distributed tracing system and fault tree analysis system according to an implementation of the disclosed subject matter.

FIG. 4 shows the computing system according to an implementation of the disclosed subject matter.

FIG. 5 show a network configuration according to an implementation of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of the disclosure can be practiced without these specific details, or with other methods, components, materials, etc. In other instances, well-known structures and devices are shown in block diagram form to facilitate describing the subject disclosure.

Implementations of the disclosed subject matter provide systems and methods of distributed tracing, dependency mapping, and fault tree analysis. These systems and methods may determine how components of code interact with one another, and may determine observed failure rates of components and the predicted failure rate of components that have been changed based on the observed failure rates.

That is, the implementations of the disclosed subject matter may determine an observed failure rate for one or more components (i.e., an actual failure rate). A predicted failure rate may be determined after changes are made to one or more components that have observed failure rates that are determined to be root causes to system failures. Such root causes may be when the observed failure rates are greater than or equal to a predetermined threshold failure level. The systems and methods of the disclosed subject matter may display the observed failure rate of one or more components, and after making changes to the components, display if a predicted failure rate of the changed components reduces the failure rate when compared to the observed failure rates of the one or more components before changes were made.

The systems and methods of the disclosed subject matter may generate a dependency map, which may show how the components of code relate to and/or interact with one another. The dependency map may be generated from trace data from a distributed tracing operation. An observed failure rate may be determined based on failures of upstream and downstream dependencies. A fault tree analysis map may be generated, and may show both the dependencies of components and their observed failure rates. When components are changed based on the observed failure rates, a fault tree analysis may be generated that includes the dependencies of the changed components, the predicted failure rates of the changed components, and the observed failure rates of the components prior to the changes.

The systems and methods of the disclosed subject matter determine both the “observed” and “predicted” failure rates, percentages, and/or probabilities, and may display these rates with the fault tree analysis map. By using the “observed” and “predicted” failure probabilities, the changes to components may be evaluated for effectiveness based on the predicted failure rates and observed failure rates.

Implementations of the disclosed subject matter may provide a ranked report of components that are the most troublesome components based on the observed failure rates. In some implementations, a ranked report of components may be provided based on predicted failure rates of one or more changed components.

Unlike traditional systems which only show a relationship between software components, the implementations of the present invention may generate and display a dependency map which shows the logical relationships between components (e.g., using Boolean AND/OR operators), and shows the observed failure rates of components. Changes to components may be made based on the observed failure rates, and predicted failure rates for the changed components may be determined. The observed failure rates and predicted failure rates of components may be tracked, and may be used to determine whether the changed components improve reliability, operability, functionality, and/or performance of the computing system. That is, the implementations determine an observed failure rate of particular components, a predicted failure rate of particular components that may be changed based on the observed failure rate, and provide a visualization of the failure rates with the dependencies of the components. The operation of the system may be improved by determining which components may cause significant failure, changing the determined components, and making components redundant so as to avoid systemic failures or to improve the operation of components to reduce systemic failures. That is, the disclosed systems improve reliable performance of computing system and handling received requests with reduced failure.

Components identified by the implementations of the disclosed subject matter as having observed failure rates and/or predicted failure rates over a predetermined threshold level may be changed, modified, and/or replaced. For example, continuous integration continuous deployment (CI/CD) server systems may provide integrated code testing, version control, deployment, distributed tracing, and visualization of test results of code builds and/or components having one or more code changes. Instrumentation libraries and distributed tracing systems may be used to provide different test phases (e.g., unit tests, integration tests, deployment tests, and the like) for the code changes and/or the new code build, and may be used to test and/or monitor the operation of the deployed new code build for one or more production environments (e.g., different data center locations and the like). For example, components and/or code may be tested and deployed using the systems and methods disclosed in the patent application entitled “Systems and Methods of Integrated Testing and Deployment in a Continuous Integration Continuous Deployment (CICD) System,” which was filed in the U.S. Patent and Trademark Office on Jul. 2, 2018 as application Ser. No. 16/025,025, and is incorporated by reference herein in its entirety.

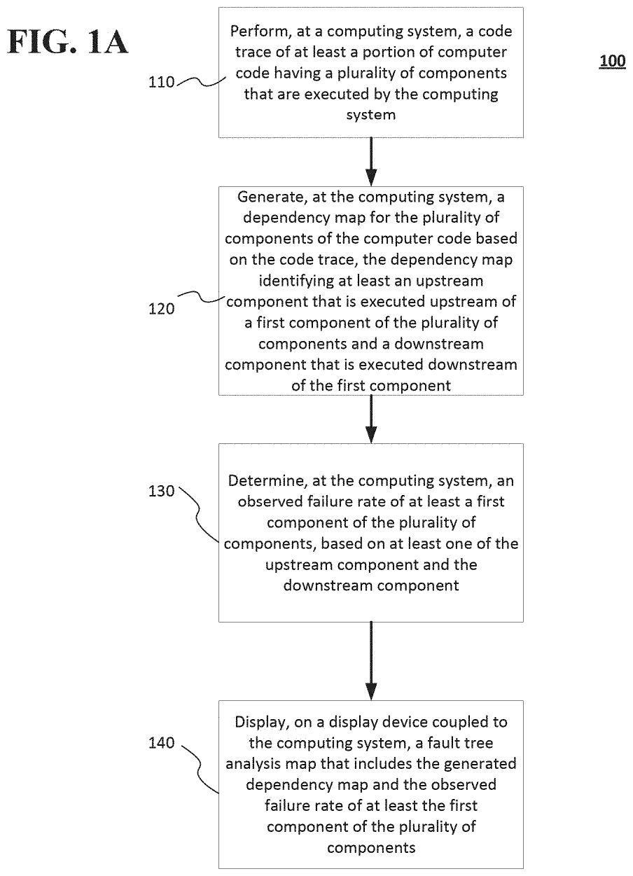

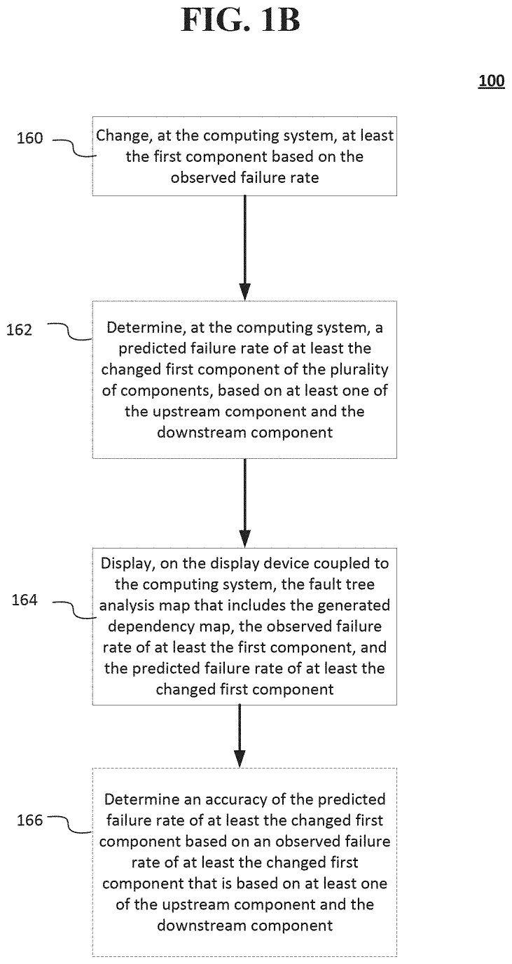

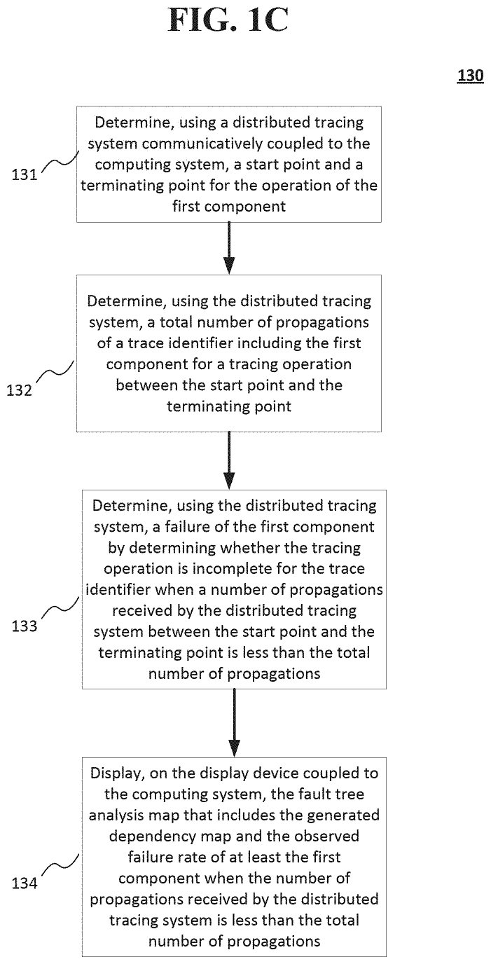

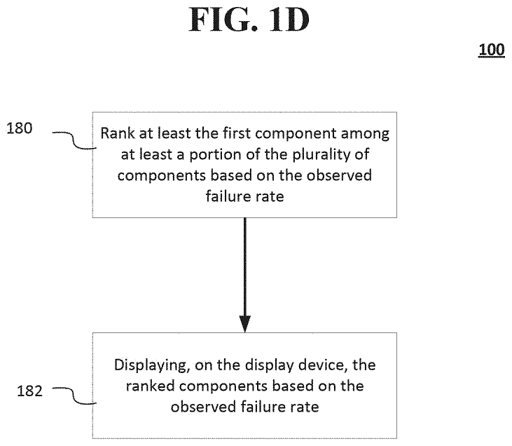

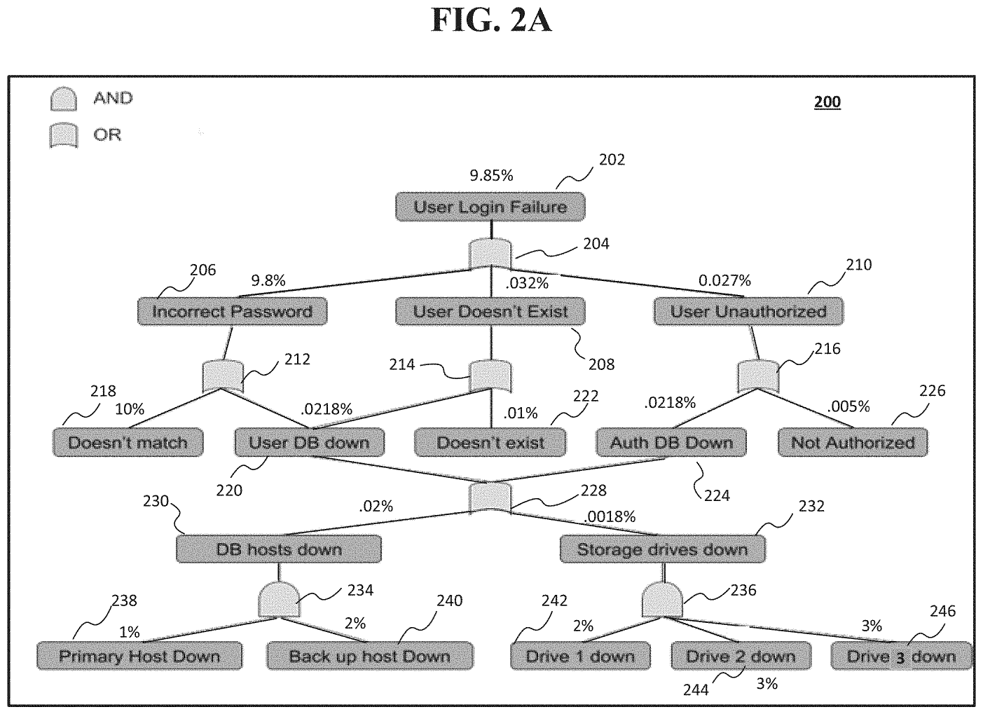

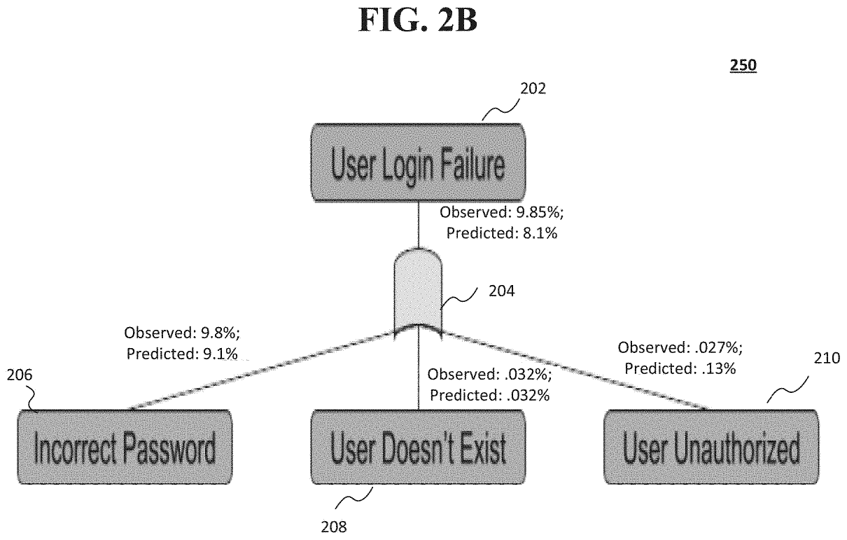

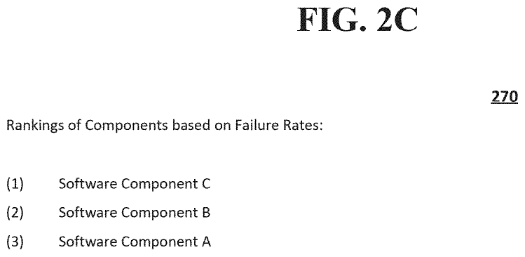

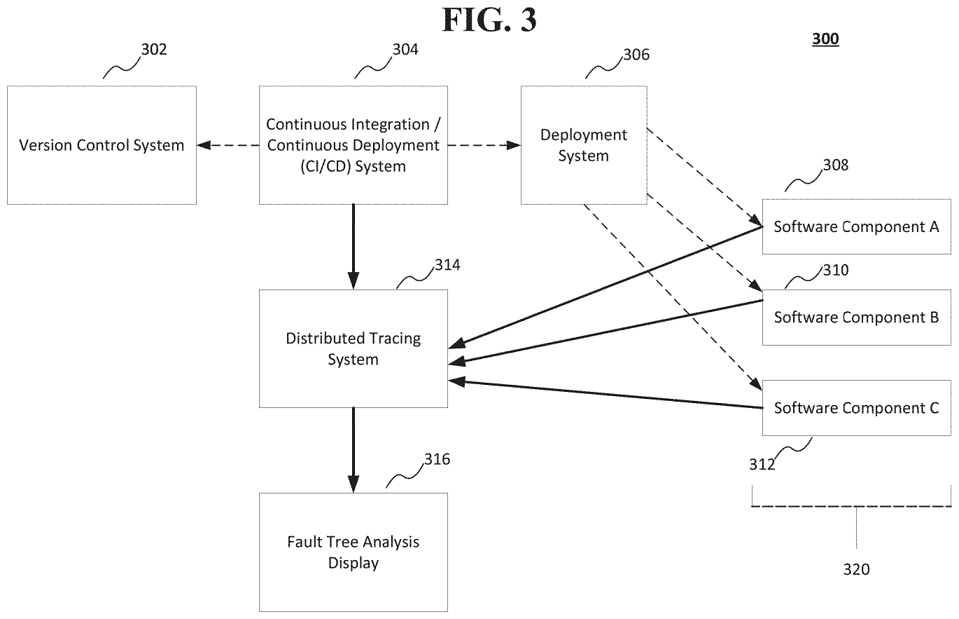

FIGS. 1A-1D show a method 100 of performing a code trace, generating a dependency map, and generating a fault tree analysis map including the dependencies between components, observed failure rates, and predicted failure rates of the components according to implementations of the disclosed subject matter. At operation 110 of FIG. 1A, a code trace may be performed on at least a portion of computer code having a plurality of components that are executed by a computing system. For example, a trace may be performed by computing system 300 on a software component 308, a software component 310, and/or a software component 312 that are executed by computing system 320 shown in FIG. 3 and described below. The computing system (e.g., computing system 300) may generate a dependency map for the plurality of components of the computer code based on the code trace at operation 120. The dependency map may identify at least an upstream component that is executed upstream of a first component of the plurality of components and a downstream component that is executed downstream of the first component. As discussed below, the dependency map may be included in a fault tree analysis map 200 shown in FIG. 2A and/or in fault tree analysis map 250 shown in FIG. 2B. The trace may be performed to determine operability, potential failure points, and/or actual failure points of the code and the components of the computing system executing the code.

The computing system may determine an observed failure rate of at least a first component of the plurality of components, based on at least one of an upstream component and a downstream component at operation at operation 130. For example, in the fault tree analysis map 200 shown in FIG. 2A, the observed failure rate of a user login operation may be determined from at least one component, such as an incorrect password, a username or user identifier provided at login does not exist within the computing system database records, and/or the user is not authorized to access particular computing system hardware and/or software. Determining the observed failure rate at operation 130 may include determining a start point and a terminating point for the operation of a component. The start point may be the beginning operation point of the component, and the terminating point may be where the component potentially fails or where the operations performed by the component are complete. Using a distributed tracing system (e.g., distributed tracing system 314 shown in FIG. 3 and described below), a total number of propagations of a trace identifier may be predicted and/or determined for a component in a tracing operation between the start point and the terminating point. An observed failure rate of a component may be determined by predicting a number of propagations received by the distributed tracing system between the start point and the terminating point is less than the total number of propagations. If the failure of a component is being determined, the number of propagations received may be counted and/or estimated, for example, based on the operations performed by the component, the number of dependencies on other components (e.g., either upstream and/or downstream), the hardware components of the computing system, and the total number of propagations. The determining of the observed failure rate of a component at operation 130 is discussed in detail below in connection with FIG. 1C.

A fault tree analysis map (e.g., fault tree analysis map 200 shown in FIG. 2A) that includes the generated dependency map and the determined observed failure rate of at least the first component of the plurality of components may be displayed on a display device (e.g., as part of the fault tree analysis display 316 of computing system 300 shown in FIG. 3) coupled to the computing system 300 as operation 140. That is, the fault tree analysis may be generated based on the dependency map generated at operation 120 and the observed failure rates for components may be determined at operation 130. In some implementations, displaying the generated fault tree analysis map at operation 140 may include a logical relationship between the plurality of components, such as shown in the fault tree analysis map 200 in FIG. 2A and described below.

FIG. 1B may shows additional detail of method 100 according to implementations of the disclosed subject matter. In particular, FIG. 1B shows the operations of determining a predicted failure rate for a component that is changed, based on the observed failure rate of the component. At operation 160 the computing system (e.g., computing system 300) may change and/or receive a change at least the first component based on the observed failure rate. At operation 162, the computing system may determine a predicted failure rate of at least the changed first component of the plurality of components, based on at least one of the upstream component and the downstream component. For example, a start point and a terminating point for the operation of the changed first component may be predicted and/or estimated. The distributed tracing system (e.g., distributed tracing system 314) may estimate a total number of propagations of a trace identifier including the first component for a tracing operation between the estimated start point and the terminating point. The distributed tracing system may predict a failure of the changed first component by determining and/or estimating whether the tracing operation is incomplete for the trace identifier. That is, a failure for the changed component may be estimated by determining when a number of propagations that may be received by the distributed tracing system between the start point and the terminating point is less than the total number of propagations.

At operation 164, the display device (e.g., as part of the fault tree analysis display 316 shown in FIG. 3) may display the fault tree analysis map that includes generated dependency map, the observed failure rate for at least the first component, and the predicted failure rate of at least the changed first component of the plurality of components. For example, FIG. 2B may show a portion of a fault tree analysis map 250 that includes dependencies between components, observed failure rates of at least the first component, and predicted failure rates of at least the changed first component. In some implementations, such as shown in optional operation 166, the computing system 300 may determining an accuracy of the predicted failure rate of at least the changed first component of the plurality of components based on the observed failure rate of at least the first component and/or the changes made to the first component.

FIG. 1C shows detailed example operations for determining an observed failure of at least the first component of the plurality of components for operation 130 shown in FIG. 1A according to an implementation of the disclosed subject matter. At operation 131, a distributed tracing system (e.g., distributed tracing system 314 shown in FIG. 3) communicatively coupled to the computing system (e.g., computing system 300 shown in FIG. 3), may determine a start point and a terminating point for the operation of the first component. The start point may be when the operation and/or execution of the first component begins. The terminating point may be a determined failure of the first component, and/or completion of the operation of the first component. At operation 132, the distributed tracing system may determine a total number of propagations of a trace identifier including the first component for a tracing operation between the start point and the terminating point. At operation 133, the distributed tracing system may determine an observed failure rate of the first component by determining whether the tracing operation is incomplete for the trace identifier when a number of propagations received by the distributed tracing system between the start point and the terminating point is less than the total number of propagations. In some implementations, the display device of the fault tree analysis display 316 may display the fault tree analysis map that includes the generated dependency map and the observed failure rate of at least the first component when the number of propagations received by the distributed tracing system is less than the total number of propagations. For example, the fault tree analysis map 250 shown in FIG. 2B includes dependencies between components, observed failure rates of components, and predicted failure rates of one or more changed components.

FIG. 1D shows additional detail of method 100 according to implementations of the disclosed subject matter. At operation 180, the computing system 300 may rank at least the first component among at least a portion of the plurality of components (e.g., software component 308, software component 310, and/or software component 312 shown in FIG. 3) based on the observed failure rate. At operation 182, the display device of the fault tree analysis display 316 may display the ranked components based on the observed failure rate. As shown in FIG. 2C and discussed below, the display 270 may include the ranked components. In some implementations, the first component may be ranked among at least a portion of the plurality of components based on observed failure rates of the components, and/or may be ranked based on both the predicted failure rate of changed components and/or observed failure rates of components, such as those determined by operations 131, 132, 133, and/or 134 shown in FIG. 1C.

FIG. 2A shows an example generated fault tree analysis map 200 that may be displayed that includes observed failure rates according to an implementation of the disclosed subject matter. The fault tree analysis map 200 may include the dependency map generated by the distributed tracing system 314 shown in FIG. 3. That is, the dependency map may show the logical relationship (e.g., using logical operators, such as AND, OR, or the like) between the components. The fault tree analysis map 200 may include the observed failure rates.

The deployment system 306 of FIG. 3 may include instrumentation libraries, which may be used to track the deployment of code (e.g., one or more of software component 308, software component 310, software component 312, or the like) on computing system 320. In the example shown in FIG. 2A, a root request made to one of the software components 308, 310, and/or 312 may be a user attempting to login to computing system 320. The root request (i.e., that the request is a login) may be determined by the instrumentation libraries of the deployment system 306.

The fault tree analysis map 200 may show an example analysis for a user login operation for a computing system that executes one or more software components, and what system and/or software components may potentially fail, thus leading to the login failure. As shown at “user login failure” node 202 (i.e., the root node of the fault tree analysis map 200), a user login may have an observed failure rate of 9.85%. That is, a user login may typically succeed 90.15% of the time. The observed failure and login success rates may be determined based on a trace, which determines the logical relationship between components, as well as whether there was a failure in a chain of propagations (e.g., of a trace identifier by the distributed tracing system; i.e., whether the number of propagations received by the distributed tracing system is less than a total number of expected propagations between a start point and the terminating point). Using the observed failure rate as a reference, the systems and methods of the disclosed subject matter may predict failure rates for components that may be changed based on the observed failure rates. Determining the observed failure rates and the logical relationship between components is discussed above in connection with FIGS. 1A and 1C, and determining the predicted failure rates of changed components is discussed above in connection with FIG. 1B.

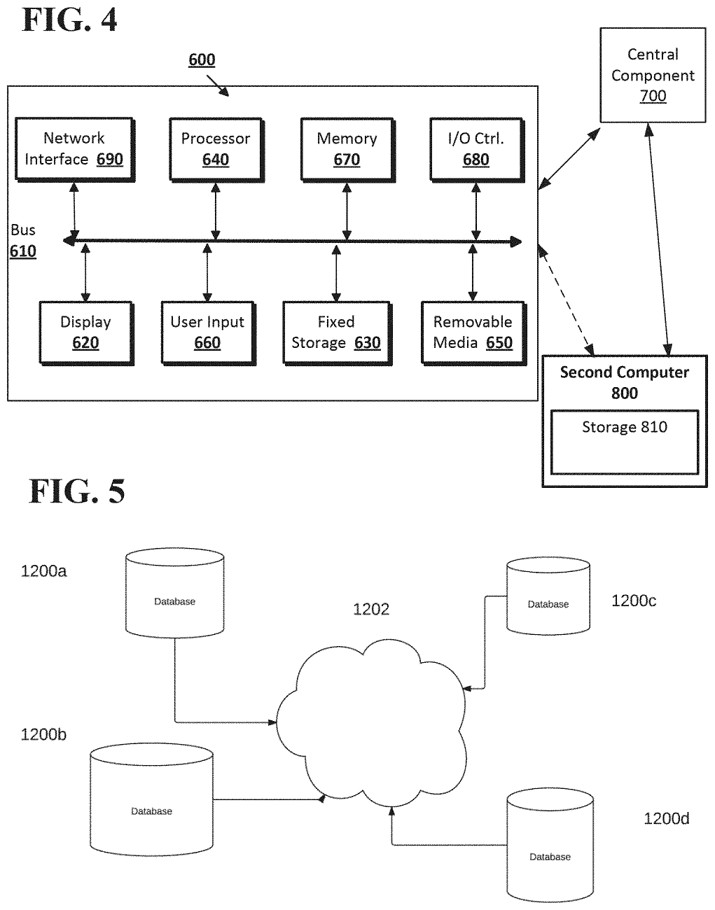

The computing system 300 may post-process a trace to determine what caused the failure (e.g., a login failure, such as shown in FIG. 2A) and the observed failure rate. That is, the failure rate at each of the nodes of a dependency tree may be determined, along with the logical relationship between the components. As shown in FIG. 2A, the root node (i.e., the “user login failure” node 202) may have a logical OR (204) relationship with “incorrect password” node 206, “user doesn't exist” node 208, and “user unauthorized” node 210. The “incorrect password” node 206 may be related to when a password entered by a user does not match the password for the user stored in a system database (e.g., storage 630 and/or storage 810 shown in FIG. 4, and/or database systems 1200a-1200d shown in FIG. 5). The “user doesn't exist” node 208 may be related to when a user identifier is entered that does not match any user identifier records stored in the database. The “user unauthorized” node 210 may be related to when a user may enter a correct user identifier and password, but the user does not have access rights to a particular system, software, and/or data according to used access information stored in the database. The “incorrect password” node 206 may have an observed failure rate of 9.8%, the “user doesn't exist” node 208 may have an observed failure rate of 0.032%, and the “user unauthorized” node 210 may have an observed failure rate of 0.027%.

The “incorrect password” node 206 may have a logical OR (212) relationship with “doesn't match” node 218 and “user DB down” node 220. The “doesn't match” node 218 may relate to when the password entered by the user does not match the password stored in the database for the user identifier. The “user DB down” node 220 may be related to a user database (DB) being inoperable at the time of a login attempt, such that the password for the user identifier cannot be located. The “doesn't match” node 218 may have an observed failure rate of 10% and the “user DB down” node 220 may have an observed failure rate 0.0218%. The “user doesn't exist” node 208 may have a logical OR (214) relationship with the “user DB down” node 220 and the “doesn't exist” node 222, which may have an observed failure rate of 0.01%.

The “user unauthorized” node 210 may have a logical OR (216) relationship with “authorization DB down” node 224 and “not authorized” node 226. The “authorization DB down” node 224 may be related to when a database having records containing which users may have authorized access to a system, software, and/or data is not operable at the time of the attempted user login. The “not authorized” node 226 may be related to when the user login information is correct, but the user is not authorized to access a particular system, software, and/or data. The “authorization DB down” node 224 may have an observed failure rate of 0.218%, and “not authorized” node 226 may have an observed failure rate of 0.005%.

The “user DB down” node 220 and the “authorization DB down” node 224 may have an OR logical relationship (228) with “DB hosts down” node 230 and “storage drives down” node 232. The “DB hosts down” node 230 may be related to when hardware which hosts a database is not operational at the time of the user login attempt. The “storage drives down” node 232 may be related to when digital storages devices that store user login information (e.g., user identifier and/or password) are not operation at the time of the login attempt. The “DB hosts down” node 230 may have an observed failure rate of 0.02% and the “storage drives down” node 232 may have an observed failure rate of 0.0018%.

The “DB hosts down” node 230 may have a logical AND relationship (234) to “primary host down” node 238 and “backup host down” node 240. The “primary host down” node 238 may be related to when the primary hardware which hosts a database having user login information is not operable at the time of the attempted login. The “backup host down” node 240 may be related to when the secondary hardware (i.e., not the primary hardware) which hosts a database having user login information is not operable at the time of the attempted login. The “primary host down” node 238 may have an observed failure rate of 1% and backup host down node 240 may have an observed failure rate of 2%.

The “storage drives down” node 232 may have a logical AND relationship (236) with “drive 1 down” node 242, “drive 2 down” node 244, and “drive 3 down” node 246. The “drive 1 down” node 242 may be related to when a first storage drive that may contain user login information is not operable at the time of the login attempt. The “drive 2 down” node 244 may be related to when a second storage drive that may contain user login information is not operable at the time of the login attempt. The “drive 3 down” node 246 may be related to when a third storage drive that may contain user login information is not operable at the time of the login attempt. The storage drives may be part of the storage 630 and/or storage 810 shown in FIG. 4, and/or the database systems 1200a-1200d shown in FIG. 5. The “drive 1 down” node 242 may have an observed failure rate of 2%, the “drive 2 down” node 244 may have an observed failure rate of 3%, and the “drive 3 down” node 246 may have an observed failure rate of 3%.

In the example fault tree analysis map 200 shown in FIG. 2A, the largest observed failure (10%) is attributed to receiving a password that does not match the one stored for the user (e.g., “doesn't match” node 218), such as when a user does not enter the correct password, or types their password incorrectly.

Instrumentation libraries, such as those that may be included with the deployment system 306 may determine if a downstream operation is an AND logical operation or an OR logical operation in order to generate the fault tree analysis map 200 shown in FIG. 2A. As shown in the fault tree analysis map 200, most of the logical relationships between the nodes are OR operations, as software and/or hardware components may fail for one or more reasons. In the example shown in FIG. 2A, redundancy may be built into systems, where multiple hosts may make databases work. If primary host has a failure (e.g., primary host down node 238), then a backup host would also have to experience a failure (e.g., backup host down 240) in order for the database to fail (e.g., the database that maintains records regarding authorized users and their respective passwords). Likewise, a system may have disk redundancy, so code may fail if all three disks were to be non-operational at the same time (e.g., drive 1 down node 242, drive 2 down node 244, and drive 3 down node 246). To get the disk or server failure data, the distributed tracing data may be correlated with data that tracks hardware failure. The observed failure rates (e.g., at nodes 206, 208, 210, 218, 220, 222, 224, 226, 230, 232, 238, 240, 242, 244, and 246) may affect the overall failure rate of the user login request (e.g., the “user login failure” node 202).

FIG. 2B shows a portion of an example fault tree analysis map 250 that includes observed failure rates for components, and predicted failure rates for one or more changed components according to an implementation of the disclosed subject matter. Although fault tree analysis map 250 only shows a portion of the fault tree analysis map 250, the fault tree analysis map 250 may include all of the nodes shown in fault tree analysis map 200 which include observed failure rates, along with predicted failure rates at each of the nodes based on changes to one or more of the components (e.g., software component 308, software components 310, software component 312, or the like). For example, based on the observed failure rates shown the fault tree analysis map 200 and/or the ranking of components based on failure rates (e.g., observed failure rates). In this example, the software component 308 (i.e., software component A) may be changed and/or modified based on the observed failure rates, and a predicted failure rate of the software component 312 may be determined.

The “user login failure” node 202 may have a logical OR (204) relationship with the “incorrect password” node 206, “user doesn't exist” node 208, and “user unauthorized” node 210. The “user login failure” node 202 may have an observed failure rate of 9.85%, and an observed failure rate of 8.1%. The “incorrect password” node 206 may have an observed failure rate of 9.8% and a predicted failure rate of 9.1%, the “user doesn't exist” node 208 may have both an observed failure rate and a predicted failure rate of 0.032%, and “user unauthorized” node 210 may have an observed failure rate of 0.027% and a predicted failure rate of 0.13%. The observed failure rates may be determined, for example, by the operations described above in connection with FIGS. 1A and 1C, and the predicted failure rates may be determined by the operations described above in connection with FIG. 1B.

As shown in FIG. 2B, the observed failure rates of one or more components and the predicted failure rates of changed components may be tracked, and used to determine whether the one or more changed components increase or decrease the failure rates for the components. The fault tree analysis map 250 shows the observed failure rates of particular components (e.g., of nodes 202, 206, 208, and/or 210) and/or predicted failure rates of particular changed components (e.g., of nodes 202, 206, 208, and/or 210), and provides a visualization of these failure rates with the dependencies of the components. The operation of the system (e.g., computing system 300) may be improved by determining which components may cause significant failure (e.g., predicted failure and/or actual failure that exceeds a predetermined threshold, such as, 10%-30%, 5%-50%, 10%-90%, or the like), and improving (e.g., by replacement, by revising hardware and/or software code, or the like) so as to avoid systemic failures and/or to improve the operation of components of the computing system 300 to reduce systemic failures.

FIG. 2C shows a display 270 that ranks components based on an observed failure probability according to an implementation of the disclosed subject matter. The display may be generated based on the operations shown in FIG. 1D and discussed above. In the example display 270, the software component A (e.g., software component 308 shown in FIG. 3), the software component B (e.g., software component 310), and/or software component C (e.g., software component 312 shown in FIG. 3) may be ranked, based on their observed failure rates. For example, the software component A may be associated with handling an incorrectly entered password, such as shown by incorrect password node 206. The software component B may be associated with determining whether user who is attempting login exists, such as shown by user doesn't exist node 208. The software component C may be associated with user unauthorized node 210. As shown in FIGS. 2A and described above, the incorrect password node 206 may have an observed failure rate of 9.8% and a predicted failure rate of 9.1%, the user doesn't exist node 208 may have both an observed failure rate and a predicted failure rate of 0.032%, and user unauthorized node 210 may have an observed failure rate of 0.027% and a predicted failure rate of 0.13%. The computing system 300 may rank the software components from lowest predicted failure rate to highest predicted failure rate, such that software component C may have the lowest observed failure rate of 0.027% and may be ranked in position 1. Software component B may have an observed failure rate of 0.032%, and may be ranked in position 2. Software component A may have an observed failure rate of 9.8%, and may be ranked in position 3. In some implementations, the software component with the highest failure rate may be ranked in position 1, and the other software components may be ranked in descending order, based on failure rate. In some implementations, the software components (e.g., changed software components) may be ranked by their predicted failure rates, and/or by considering both the predicted failure rates and observed failure rates.

FIG. 3 shows a computing system 300 that includes a distributed tracing system and fault tree analysis system according to an implementation of the disclosed subject matter. For example, the computing system 300 can be implemented on a laptop, a desktop, an individual server, a server cluster, a server farm, or a distributed server system, or can be implemented as a virtual computing device or system, or any suitable combination of physical and virtual systems. For simplicity, various parts such as the processor, the operating system, and other components of the computing system 300 are not shown. The computing system 300 may include one or more servers, and may include one or more digital storage devices communicatively coupled thereto, for a version control system 302, a continuous integration and continuous deployment (CI/CD) system 304, a deployment system 306, a distributed tracing system 314, a fault tree analysis system 316, and computing system 320 (e.g., which may execute include software component 308, software component 310, and/or software component 312). In some implementations, the computing system 300 may be at least part of computer 600, central component 700, and/or second computer 800 shown in FIG. and discussed below, and/or database systems 1200a-1200d shown in FIG. 5 and discussed below. The computing system 300 may perform one or more of the operations shown in FIGS. 1A-1D, and may output one or more of the displays shown in FIGS. 2A-2C.

Computing system 320 may be a desktop computer, a laptop computer, a server, a tablet computing device, a wearable computing device, or the like. In some implementations, the developer computer may be separate from the computing system 300, and may be communicatively coupled to the computing system 300 via a wired and/or wireless communications network.

The CI/CD system 304 may perform a new code build using the code change (e.g., a change to one or more of the software components) provided by a developer computer (not shown) and/or from computing system 320, and may generate a change identifier for each code change segment of one or more software components. The CI/CD system 304 may manage the new code build, and the testing of the new code build. The version control system 302 may store one or more versions of code built by the CI/CD system 304. For example, the version control system may store the versions of code in storage 810 of second computer 800 shown in FIG. 4, and/or in one or more of the database systems 1200a-1200d shown in FIG. 5.

An instrumentation library may be part of the CI/CD system 304 that may manage the at least one phase of testing of the new code build that includes one or more of the changes software components. The deployment system 306 may manage the deployment of the new code build that has been tested for the at least on test phase to at least one production environment (e.g., one or more datacenters that may be located at different geographic locations). An instrumentation library may be part of the deployment system 306, and may manage the testing and/or monitoring of the deployed new code build. In some implementations, the CI/CD system 304 may manage a rollback operation when it is determined that changed code and/or the deployed new code build fails a production environment test. In some implementations, the CI/CD system 304 may manage a rollback operation when any failure of the computing system 300 is determined (e.g., hardware failure, network failure, or the like).

The distributed tracing system 314 may determine timing information for one or more operations and/or records, which may be used to perform a trace operation for code of a software component (e.g., software component 308, software component 310, and/or software component 312). The fault tree analysis display 316 may generate and/or display the results of the generation of a dependency map of a trace, determined failure probabilities of components, and/or actual failures of component. The fault tree analysis display 316 may generate and display, for example, display 200 shown in FIG. 2A, display 250 shown in FIG. 2B, and/or display 270 shown in FIG. 2C. The fault tree analysis display 316 may be monitored and/or be accessible to the computing system 320.

Implementations of the presently disclosed subject matter may be implemented in and used with a variety of component and network architectures. FIG. 4 is an example computer 600 suitable for implementing implementations of the presently disclosed subject matter. As discussed in further detail herein, the computer 600 may be a single computer in a network of multiple computers. As shown in FIG. 4, the computer 600 may communicate with a central or distributed component 700 (e.g., server, cloud server, database, cluster, application server, etc.). The central component 700 may communicate with one or more other computers such as the second computer 800, which may include a storage device 810. The second computer 800 may be a server, cloud server, or the like. The storage 810 may use any suitable combination of any suitable volatile and non-volatile physical storage mediums, including, for example, hard disk drives, solid state drives, optical media, flash memory, tape drives, registers, and random access memory, or the like, or any combination thereof.

In some implementations, the software components 308, 310, and 312 may be executed on a computing system 320 shown in FIG. 3, and the version control system 302, continuous integration continuous deployment system 304 and related instrumentation libraries, the deployment system 306, the distributed tracing system 314 and the fault tree analysis display 316 may be at least part of the computer 600, the central component 700, and/or the second computer 800. In some implementations, the computing system 300 shown in FIG. 3 may be implemented on one or more of the computer 600, the central component 700, and/or the second computer 800 shown in FIG. 4.

Data for the computing system 300 may be stored in any suitable format in, for example, the storage 810, using any suitable filesystem or storage scheme or hierarchy. The stored data may be, for example, generated dependency maps, predicted failure rates of components, actual failure rates of components, software components, and the like. For example, the storage 810 can store data using a log structured merge (LSM) tree with multiple levels. Further, if the systems shown in FIGS. 4-5 are multitenant systems, the storage can be organized into separate log structured merge trees for each instance of a database for a tenant. For example, multitenant systems may be used to store generated dependency maps, observed failure rates of components, predicted failure rates of components, or the like. Alternatively, contents of all records on a particular server or system can be stored within a single log structured merge tree, in which case unique tenant identifiers associated with versions of records can be used to distinguish between data for each tenant as disclosed herein. More recent transactions (e.g., updated predicted failure rates for components, updated observed failure rates of components, new or updated dependency maps, code updates, new code builds, rollback code, test result data, and the like) can be stored at the highest or top level of the tree and older transactions can be stored at lower levels of the tree. Alternatively, the most recent transaction or version for each record (i.e., contents of each record) can be stored at the highest level of the tree and prior versions or prior transactions at lower levels of the tree.

The information obtained to and/or from a central component 700 can be isolated for each computer such that computer 600 cannot share information with computer 800 (e.g., for security and/or testing purposes). Alternatively, or in addition, computer 600 can communicate directly with the second computer 800.

The computer (e.g., user computer, enterprise computer, etc.) 600 may include a bus 610 which interconnects major components of the computer 600, such as a central processor 640, a memory 670 (typically RAM, but which can also include ROM, flash RAM, or the like), an input/output controller 680, a user display 620, such as a display or touch screen via a display adapter, a user input interface 660, which may include one or more controllers and associated user input or devices such as a keyboard, mouse, Wi-Fi/cellular radios, touchscreen, microphone/speakers and the like, and may be communicatively coupled to the I/O controller 680, fixed storage 630, such as a hard drive, flash storage, Fibre Channel network, SAN device, SCSI device, and the like, and a removable media component 650 operative to control and receive an optical disk, flash drive, and the like.

The bus 610 may enable data communication between the central processor 640 and the memory 670, which may include read-only memory (ROM) or flash memory (neither shown), and random access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 600 may be stored on and accessed via a computer readable medium, such as a hard disk drive (e.g., fixed storage 630), an optical drive, floppy disk, or other storage medium 650.

The fixed storage 630 can be integral with the computer 600 or can be separate and accessed through other interfaces. The fixed storage 630 may be part of a storage area network (SAN). A network interface 690 can provide a direct connection to a remote server via a telephone link, to the Internet via an internet service provider (ISP), or a direct connection to a remote server via a direct network link to the Internet via a POP (point of presence) or other technique. The network interface 690 can provide such connection using wireless techniques, including digital cellular telephone connection, Cellular Digital Packet Data (CDPD) connection, digital satellite data connection or the like. For example, the network interface 690 may enable the computer to communicate with other computers and/or storage devices via one or more local, wide-area, or other networks, as shown in FIGS. 3-5.

Many other devices or components (not shown) may be connected in a similar manner (e.g., the computing system 300 shown in FIG. 3, data cache systems, application servers, communication network switches, firewall devices, authentication and/or authorization servers, computer and/or network security systems, and the like). Conversely, all the components shown in FIGS. 4-5 need not be present to practice the present disclosure. The components can be interconnected in different ways from that shown. Code to implement the present disclosure (e.g., for the computing system 300, the software components 308, 310, and/or 312, or the like) can be stored in computer-readable storage media such as one or more of the memory 670, fixed storage 630, removable media 650, or on a remote storage location.

FIG. 7 shows an example network arrangement according to an implementation of the disclosed subject matter. Four separate database systems 1200a-d at different nodes in the network represented by cloud 1202 communicate with each other through networking links 1204 and with users (not shown). The database systems 1200a-d may be, for example, different production environments of the CICD server system 500 that code changes may be tested for and that may deploy new code builds. In some implementations, the one or more of the database systems 1200a-d may be located in different geographic locations. Each of database systems 1200 can be operable to host multiple instances of a database (e.g., that may store generated dependency maps, observed failure rates of components, predicted failure rates of components, software components, code changes, new code builds, rollback code, testing data, and the like), where each instance is accessible only to users associated with a particular tenant. Each of the database systems can constitute a cluster of computers along with a storage area network (not shown), load balancers and backup servers along with firewalls, other security systems, and authentication systems. Some of the instances at any of systems 1200 may be live or production instances processing and committing transactions received from users and/or developers, and/or from computing elements (not shown) for receiving and providing data for storage in the instances.

One or more of the database systems 1200a-d may include at least one storage device, such as in FIG. 6. For example, the storage can include memory 670, fixed storage 630, removable media 650, and/or a storage device included with the central component 700 and/or the second computer 800. The tenant can have tenant data stored in an immutable storage of the at least one storage device associated with a tenant identifier.

In some implementations, the one or more servers shown in FIGS. 4-5 can store the data (e.g., code changes, new code builds, rollback code, test results and the like) in the immutable storage of the at least one storage device (e.g., a storage device associated with central component 700, the second computer 800, and/or the database systems 1200a-1200d) using a log-structured merge tree data structure.

The systems and methods of the disclosed subject matter can be for single tenancy and/or multitenancy systems. Multitenancy systems can allow various tenants, which can be, for example, developers, users, groups of users, or organizations, to access their own records (e.g., software components, dependency maps, observed failure rates, predicted failure rates, and the like) on the server system through software tools or instances on the server system that can be shared among the various tenants. The contents of records for each tenant can be part of a database containing that tenant. Contents of records for multiple tenants can all be stored together within the same database, but each tenant can only be able to access contents of records which belong to, or were created by, that tenant. This may allow a database system to enable multitenancy without having to store each tenants' contents of records separately, for example, on separate servers or server systems. The database for a tenant can be, for example, a relational database, hierarchical database, or any other suitable database type. All records stored on the server system can be stored in any suitable structure, including, for example, an LSM tree.

Further, a multitenant system can have various tenant instances on server systems distributed throughout a network with a computing system at each node. The live or production database instance of each tenant may have its transactions processed at one computer system. The computing system for processing the transactions of that instance may also process transactions of other instances for other tenants.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “transmitting,” “modifying,” “sending,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
performing, at a computing system, a code trace of at least a portion of computer code having a plurality of components that are executed by the computing system;
generating, at the computing system, a dependency map for the plurality of components of the computer code based on the code trace, the dependency map identifying at least an upstream component that is executed upstream of a first component of the plurality of components and a downstream component that is executed downstream of the first component;
determining, at the computing system, an observed failure rate of at least the first component of the plurality of components, based on at least one of the upstream component and the downstream component;
receiving, by the computing system, a change to at least the first component based on the observed failure rate;
determining, at the computing system, a predicted failure rate of at least the changed first component based on at least one of the upstream component and the downstream component; and
generating for display, on a display device coupled to the computing system, a fault tree analysis map that includes the generated dependency map, the observed failure rate of at least the first component, and the predicted failure rate of at least the changed first component.

2. (canceled)

3. The method of claim 1, further comprising:
determining an accuracy of the predicted failure rate of at least the changed first component based on an observed failure rate of at least the changed first component that is based on at least one of the upstream component and the downstream component.

4. The method of claim 1, wherein the determining the observed failure rate of at least the first component comprises:
determining, using a distributed tracing system communicatively coupled to the computing system, a start point and a terminating point for the operation of the first component;
determining, using the distributed tracing system, a total number of propagations of a trace identifier including the first component for a tracing operation between the start point and the terminating point; and
determining, using the distributed tracing system, the observed failure rate of the first component by determining whether the tracing operation is incomplete for the trace identifier when a number of propagations received by the distributed tracing system between the start point and the terminating point is less than the total number of propagations.

5. The method of claim 4, wherein the generating for display, on the display device coupled to the computing system, the fault tree analysis map comprises:
generating the fault tree analysis map that includes the generated dependency map and the observed failure rate of at least the first component for display when the number of propagations received by the distributed tracing system is less than the total number of propagations.

6. The method of claim 4, wherein the terminating point is at least one from the group consisting of: a determined failure of the first component, and completion of the operation of the first component.

7. The method of claim 1, further comprising:
ranking at least the first component among at least a portion of the plurality of components based on the observed failure rate; and
generating for display, on the display device coupled to the computing system, the ranked components based on the observed failure rate.

8. The method of claim 1, wherein the generating the fault tree analysis map for display comprises:
generating, for display on the display device coupled to the computing system, a logical relationship between the plurality of components of the fault tree analysis map.

9. A system comprising:
a digital storage device to store at least a portion of computer code having a plurality of components;
a processor to:
perform a code trace of the at least a portion of computer code having a plurality of components that are executed by the processor;
generate a dependency map for the plurality of components of the computer code based on the code trace, the dependency map identifying at least an upstream component that is executed upstream of a first component of the plurality of components and a downstream component that is executed downstream of the first component;
determine an observed failure rate of at least the first component of the plurality of components, based on at least one of the upstream component and the downstream component;
receive a change to at least the first component based on the observed failure rate;
determine a predicted failure rate of at least the changed first component based on at least one of the upstream component and the downstream component; and
generate for display, on a display device coupled to the processor, a fault tree analysis map that includes the generated dependency map, the observed failure rate of at least the first component, and the predicted failure rate of at least the changed first component.

10. (canceled)

11. The system of claim 9, wherein the processor determines an accuracy of the predicted failure rate of at least the changed first component based on an observed failure rate of at least the changed first component that is based on at least one of the upstream component and the downstream component.

12. The system of claim 9, further comprising:
a distributed tracing system communicatively coupled to the processor,
wherein the processor determines the observed failure rate of at least the first component by using the distributed tracing system to determine a start point and a terminating point for the operation of the first component, determine a total number of propagations of a trace identifier including the first component for a tracing operation between the start point and the terminating point, determine the observed failure rate of the first component by determining whether the tracing operation is incomplete for the trace identifier when a number of propagations received by the distributed tracing system between the start point and the terminating point is less than the total number of propagations.

13. The system of claim 12, wherein the processor generates the fault tree analysis map for display that includes the generated dependency map and the observed failure rate of at least the first component when the number of propagations received by the distributed tracing system is less than the total number of propagations.

14. The system of claim 12, wherein the terminating point is at least one from the group consisting of: a determined failure of the first component, and completion of the operation of the first component.

15. The system of claim 9, wherein the processor ranks at least the a first component among at least a portion of the plurality of components based on the observed failure rate, and
wherein the generated display for the display device includes the ranked components based on the observed failure rate.

16. The system of claim 9, wherein the generated display for the display device includes a logical relationship between the plurality of components of the fault tree analysis map.
